(19) United States
(12) Patent Application Publication
(10) Pub. No.: US 2017/0364248 A1
(43) Pub. Date: Dec. 21, 2017

(54) SEGMENT ERASER

(71) Applicant: MICROSOFT TECHNOLOGY LICENSING, LLC, Redmond, WA (US)

(72) Inventors: Emily Tran, Redmond, WA (US); Daniel Yancy Parish, Kirkland, WA (US); Tyler Adams, Seatle, WA (US); Larry Tucker Hatfield, Kirkland, WA (US)

(73) Assignee: MICROSOFT TECHNOLOGY LICENSING, LLC, Redmond, WA (US)

(21) Appl. No.: 15/183,826

(22) Filed: Jun. 16, 2016

(51) Int. Cl. G06F 3/0484; G06T 11/60; G06T 3/60; G06F 3/0482; G06T 3/40; G06T 3/00; G06T 19/20; G06T 11/00

(52) U.S. Cl. CPC G06F 3/04845; G06T 19/20; G06T 11/60; G06T 11/001; G06F 3/0482; G06T 3/40; G06T 3/0006; G06T 3/60

(57) ABSTRACT

Technologies are described for a segment eraser, where predefined graphical shapes or ink entries (hand drawn shapes through touch, gesture, or similar input) are modified through deletion of one or more segments, rotation, resizing, color changes, and comparable ones. Binary shape operations such as union combination, fragmenting intersection, and subtraction are performed on underlying shapes to create new shapes in predictable ways. A segment eraser according to embodiments works from endpoint to endpoint of the underlying shape outlines, on dosed shape areas when the shapes have no outline, and on dry ink strokes up to intersections with other ink entries.

### BACKGROUND

Many applications such as word processing applications, graphics applications, presentation applications, and similar ones utilize various forms of graphics and, increasingly, ink entries to create, annotate, and otherwise process content. Even simple forms of graphics may take may shapes and forms. Thus, providing the ability to create any shape or form may be a challenge for such applications. Typically, applications provide basic shapes and allow users to create other shapes through defined operations.

Selection of proper shapes and performance of the operations may not be a user friendly endeavor, however. For example, users may first have to select one or more suitable shapes from a large library of available shapes, then select and perform operations such as union, combination, fragmenting, intersection, and subtraction through multiple menu selections. The shape selection and operations may not be easily discoverable or difficult to perform without a mouse—keyboard combination. Therefore, the process may not be user-friendly since it may take a high cognitive load to determine which order to select the shapes and which operator results in the desired effect.

Moreover, users are not provided with tools to quickly and intuitively delete segments of ink, shapes, or outlines in conventional systems. Scenarios such as making custom iconography, drawing geometric illustrations, building 3D shapes, and more may prove to be too cumbersome for non-professional users (or even professional users).

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to methods and systems to provide modification of shapes and ink entries through deletion of one or more segments. In some examples one or more ink entries or shapes to be displayed may be received and an activation of a segment eraser tool detected. Upon detection of a selection of a region with the segment eraser tool, where the region includes a portion of at least one of the ink entries or shapes, one or more segments of the ink entries or shapes within the selected region may be determined. The one or more segments of the ink entries or shapes within the selected region may then be removed and the one or more ink entries or shapes with the one or more segments removed may be displayed.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a display diagram of an example networked environment where a system for providing modification of shapes and ink entries through deletion of one or more segments may be implemented;

FIG. 2 includes a display diagram of an example local application environment where modification of shapes and ink entries through deletion of one or more segments may be implemented;

FIG. 3 illustrates a display diagram of example user interfaces for modification of shapes and ink entries through deletion of one or more segments;

FIGS. 4A and 4B illustrate example modification of shapes through deletion of one or more segments;

FIGS. 5A and 5B illustrate example modification of filled shapes without line boundaries through deletion of one or more segments;

FIG. 6 illustrates example modification of ink entries through deletion of one or more segments;

FIG. 7 is a networked environment, where a system according to embodiments may be implemented;

FIG. 8 is a block diagram of an example general purpose computing device, which may be used to provide modification of shapes through deletion of one or more segments; and

FIG. 9 illustrates a logic flow diagram of a method to provide modification of shapes through deletion of one or more segments, according to embodiments.

### DETAILED DESCRIPTION

As briefly described above, predefined graphical shapes or ink entries (hand-drawn shapes through touch, gesture, or similar input) may be modified through deletion of one or more segments, rotation, resizing, color changes, and comparable ones. Binary shape operations such as union, combination, fragmenting, intersection, and subtraction may be performed on underlying shapes to create new shapes in predictable ways. A segment eraser according to embodiments may work from endpoint to endpoint of the underlying shape outlines, on closed shape areas when the shapes have no outline, and on dry ink strokes up to intersections with other ink entries.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for graphical shape processing, specifically for segment modification. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

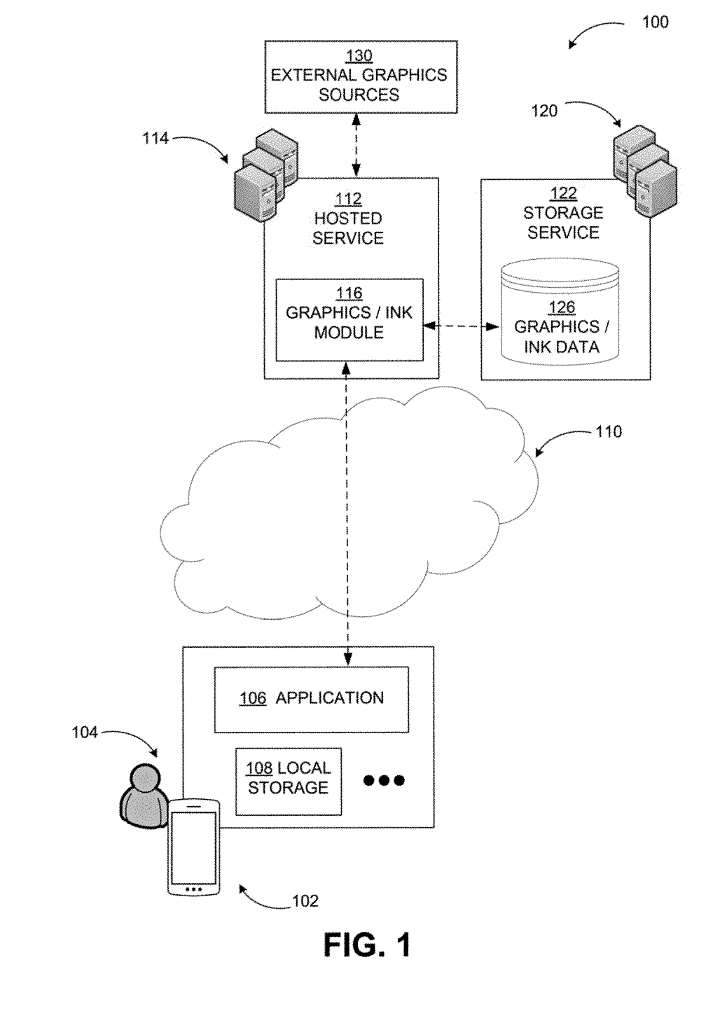

FIG. 1 includes a display diagram of an example networked environment where a system for providing modification of shapes and ink entries through deletion of one or more segments may be implemented.

As illustrated in diagram 100, a hosted service 112 executed on servers 114 may provide one or more applications such as word processing applications, presentation applications, graphics applications, note taking applications, and similar ones that may include creation, modification, and otherwise processing of shapes and ink entries. The hosted service 112 may, for example, be a productivity service. The hosted service 112 may include a graphics ink module 116 to process graphic shapes and ink entries. The hosted service 112 may also receive from and transmit to external graphics sources 130 graphic data such as modified shapes, ink entries, and the like.

Data associated with graphics and ink may be stored in one or more data stores 126 managed by a storage service 122 executed on servers 120. The hosted service 112 may provide access to its services through a thick (e.g., a locally installed client application) or a thin (e.g., a browser) application 106 executed on a device 102 through one or more networks such as network 110. The device 102 may include a desktop computer, a laptop computer, a tablet computer, a vehicle mount computer, a smart phone, or a wearable computing device, among other similar devices. User 104 may access those services and modify graphics and ink entries through deletion of one or more segments. Device 102 may also include local storage 108 for storing at least some of the data such as ink entries.

Modification of shapes and ink entries through a segment eraser tool may provide technical advantages such as increased user interaction efficiency by reducing complexity of graphic shape (or ink) creation and modification, processor and memory usage reduction by avoiding resource-costly z-layer approaches to generate new shapes or modify existing ones. Embodiments may also allow widespread use of graphics tools on mobile and portable platforms by reducing a need for precision tools such as digital drawing pens or complex applications and modules.

Embodiments, as described herein, address a need that arises from very large scale of operations created by software-based services that cannot be managed by humans. The action/operations described herein are not a mere use of a computer, but address results of a system that is a direct consequence of software used as a service offered in conjunction with large numbers of customers and applications that provide graphic and ink entry processing.

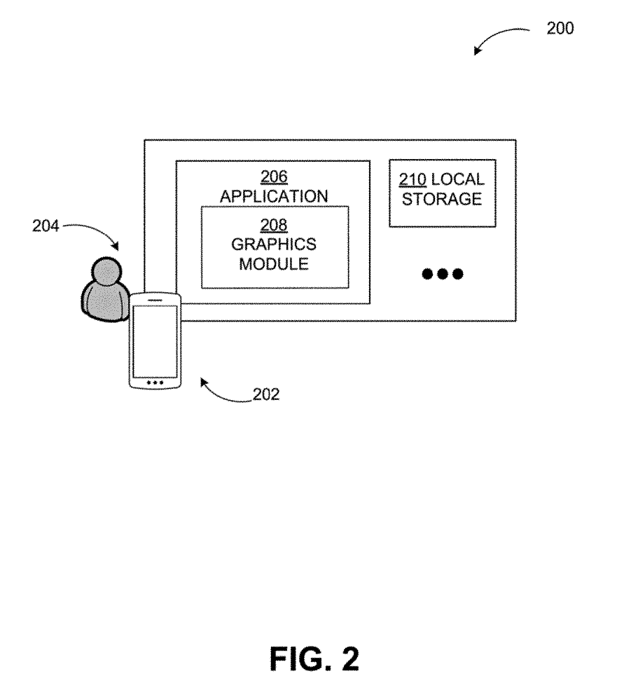

FIG. 2 includes a display diagram of an example local application environment where modification of shapes and ink entries through deletion of one or more segments may be implemented.

As illustrated in diagram 200, a user 204 may execute a locally installed application 206 such as a word processing application, a presentation application, a graphics application, a note taking application, and similar ones that may include creation, modification, and otherwise processing of shapes and ink entries among other activities. The device 202 may be a desktop computer, a laptop computer, a tablet computer, a vehicle mount computer, a smart phone, or a wearable computing device, among other similar devices. The device 202 may also include local storage 210 to store data related with application 206. In embodiments, where ink entries may be processed and modified, the device 202 may include a touch capable display or a gesture detection mechanism

The application 206 may include a graphics module 208 for processing shapes and ink entries. The graphics module 208 may modify graphical shapes or ink entries (hand-drawn shapes through touch, gesture, or similar input) through deletion of one or more segments, rotation, resizing, color changes, and comparable ones.

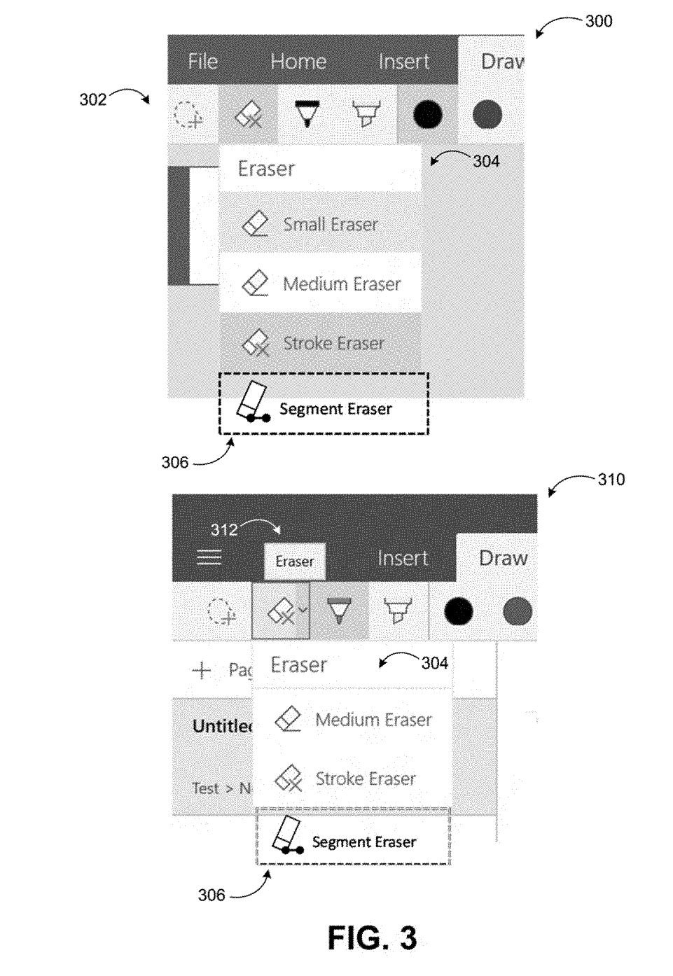

FIG. 3 illustrates a display diagram of example user interfaces for modification of shapes and ink entries through deletion of one or more segments.

As shown in a diagram 300, a segment eraser tool may be provided through an application user interface menu. For example, the segment eraser tool 306 may be part of a submenu 304 of eraser tools of a drawing tools tab 302 in the user interface 300. In another example implementation, the segment eraser tool 306 may be part of an eraser submenu 312. The segment eraser tool may also be provided through a pop-menu, a predefined touch action (e.g., a particular swipe, tap, or combination), a predefined gesture, or even eye-tracking movement. Of course, keyboard or voice commands may also be used to activate the tool. A mouse, pen, keyboard, touch, gesture, or similar input mechanism may be used to guide the segment eraser tool.

In yet other embodiments, the segment eraser tool may be provided as part of a different submenu or grouped with other controls. Furthermore, any name may be assigned to the tool configured to perform actions described herein.

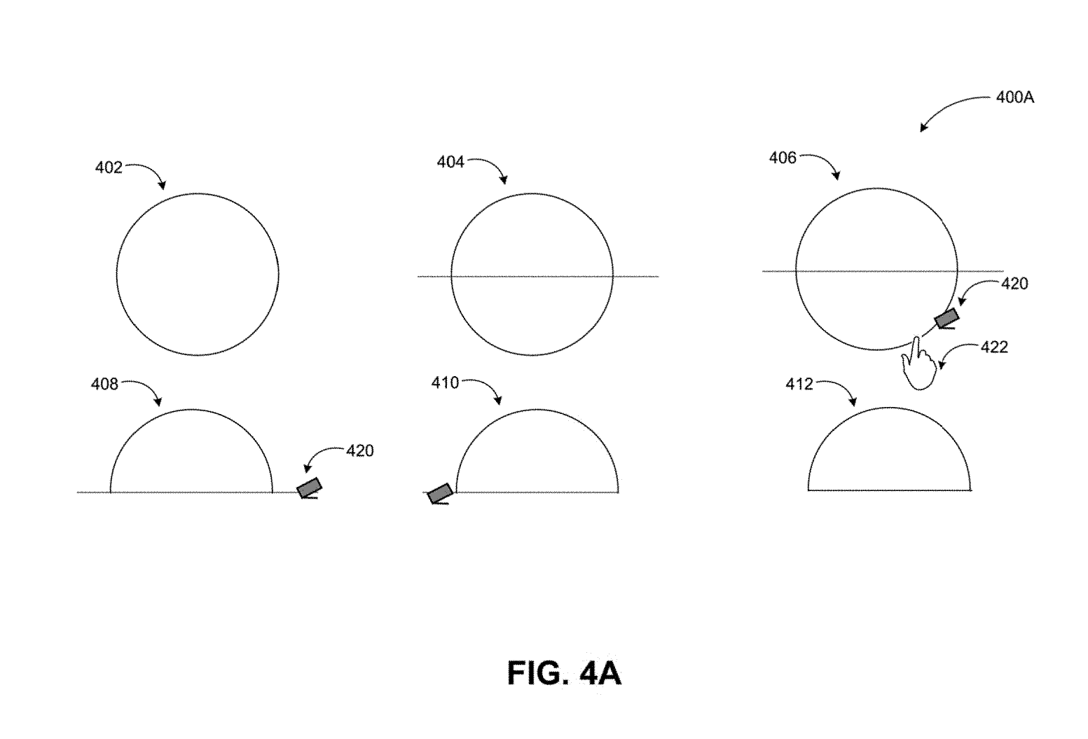

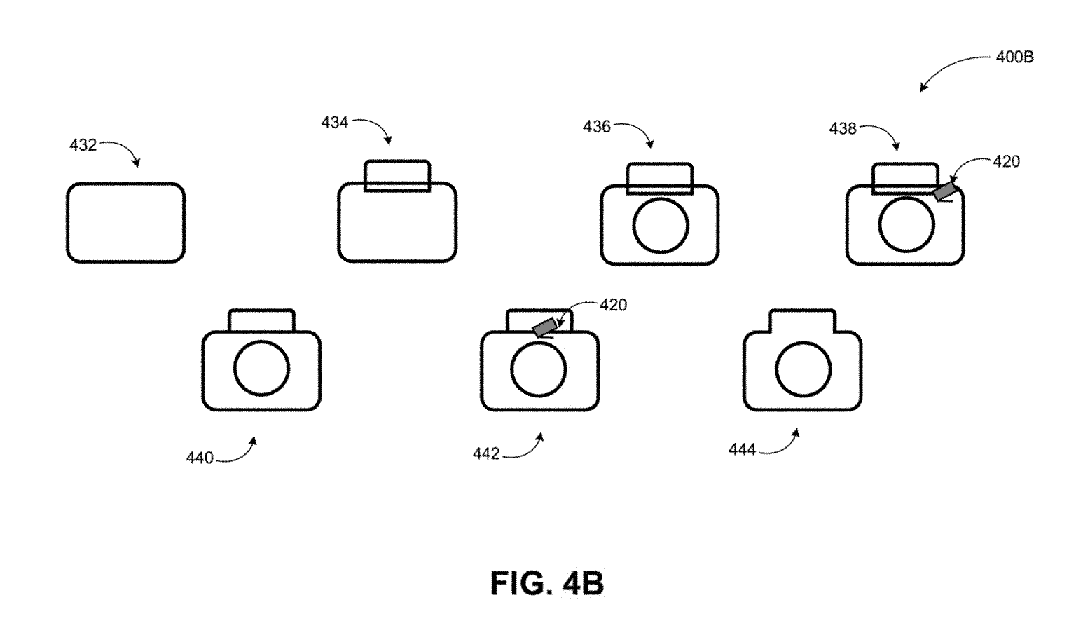

FIGS. 4A and 4B illustrate example modification of shapes through deletion of one or more segments.

Diagram 400A shows the progression of creating a semi-circle using a segment eraser tool according to embodiments. In step one (402), a full circle may be drawn followed by a line through the middle of the circle in step two (404). As shown in the figure, the line extends beyond the circle in both directions indicating accurate initial drawing is not necessary. In step three (406), a semi-circular region may be drawn around the lower half of the full circle using the segment eraser tool 420 (e.g., through touch action 422). Segments of the full circle within the drawn region may be removed leaving a semi-circle in step four (408).

At the same step, another region may be drawn containing one of the line segments extending beyond the circle and removed. At step five (410), the other line segment extending beyond the circle may be removed similarly leaving the clean semi-circle in step 6 (412) with relatively less effort on the part of the user.

Diagram 400B shows the progression of creating a camera shape using basic rectangle and circle outlines. In steps 432, 434, and 436, the user may draw two overlapping rectangles and a circle. In step 438, a portion of the upper rectangle overlapping with the lower rectangle may be removed by selecting a region to contain that portion through the segment eraser tool 420. The intermediary shape shown in step 440 may be further enhanced by selecting a portion of the lower rectangle that provides a lower boundary to the upper rectangle and removing through the segment eraser tool in step 442. That leaves a simple camera shape as shown in step 444. Using the segment eraser tool 420, a user does not need special or custom shapes, the ability to draw precise lines or other shapes, and the ability to delete existing shapes or shape segments with precise actions (e.g., drawing over the existing line).

The examples in FIGS. 4A and 4B are for outline shapes and show how complicated shapes can be created through a combination of basic shapes with simple actions using the segment eraser tool. Similar combinations and modifications may also be performed on filled shapes without outlines as discussed below.

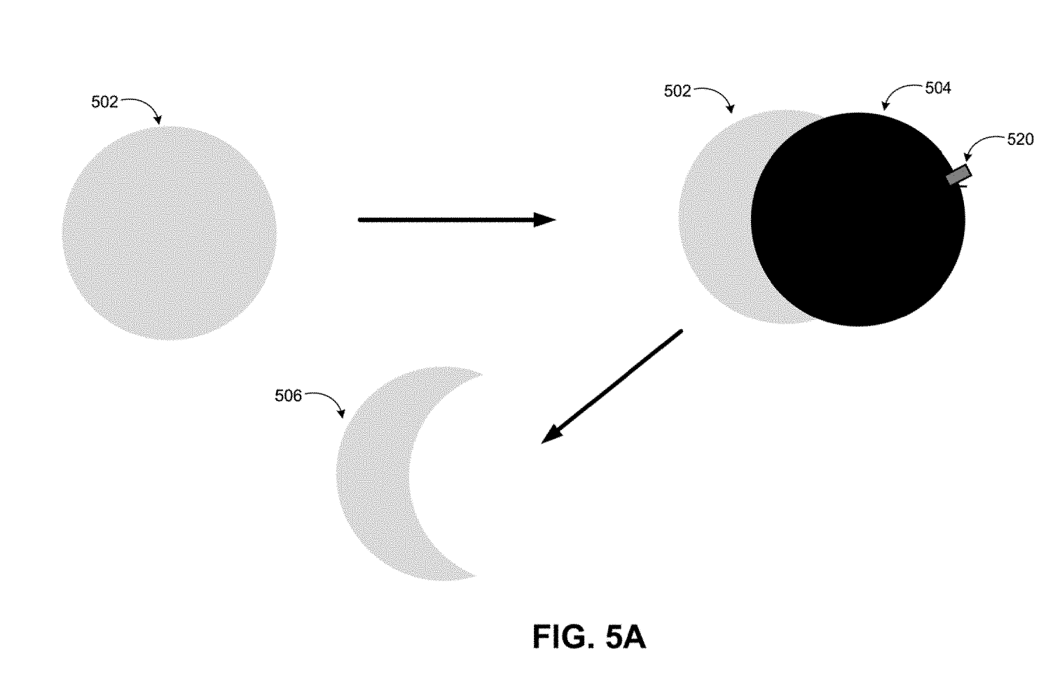

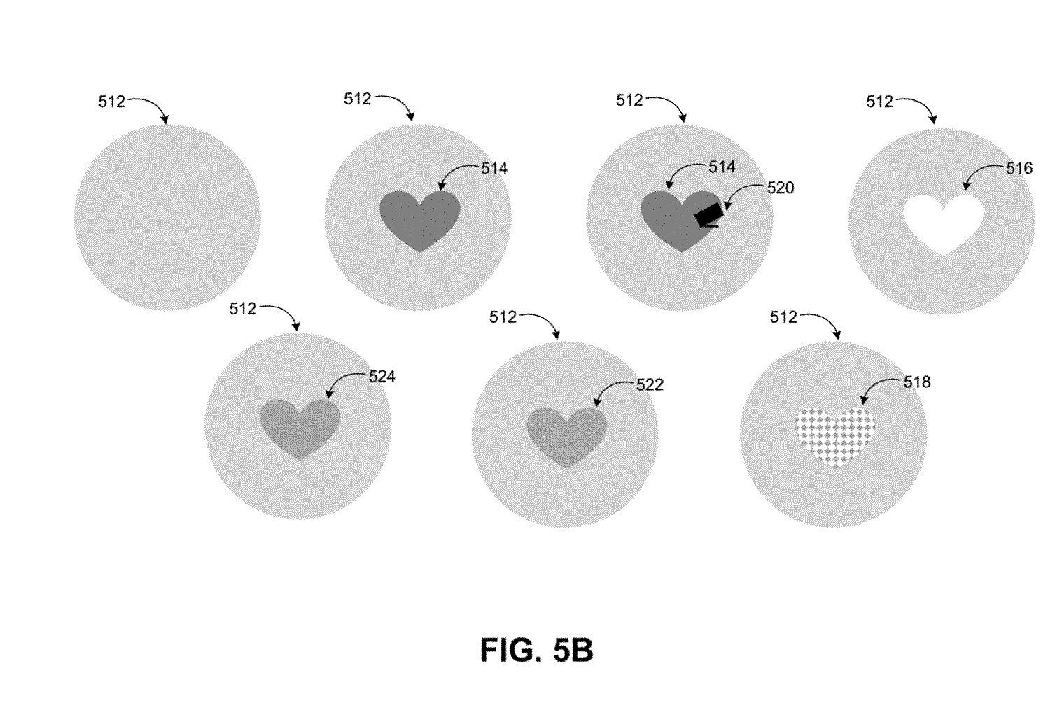

FIGS. 5A and 5B illustrate example modification of filled shapes without line boundaries through deletion of one or more segments.

In FIG. 5A, a gray filled circle 502 without an outline is created. Next, another removal circle 504 partially overlapping with the gray filled circle 502 may be drawn as the removal region using segment eraser tool 520 (e.g., using a default shape selection as opposed to free-form region drawing). As the portion (segments) of the gray filled circle 502 overlapping with the removal circle 504 are erased, a moon shape 506 may be created effortlessly as shown in the figure.

In FIG. 5B, a circle 512 is overlaid with a darker colored heart shape 514. Using the segment eraser tool 520 and a subtraction operation, the heart shape may be removed leaving the original circle 512 with a heart shaped transparent region 516 in the middle of it. The new shape may then be overlaid over different backgrounds such a textured backgrounds 524, 522, and 518 allowing different colors, textures, etc. to be placed easily in the heart shaped transparent region.

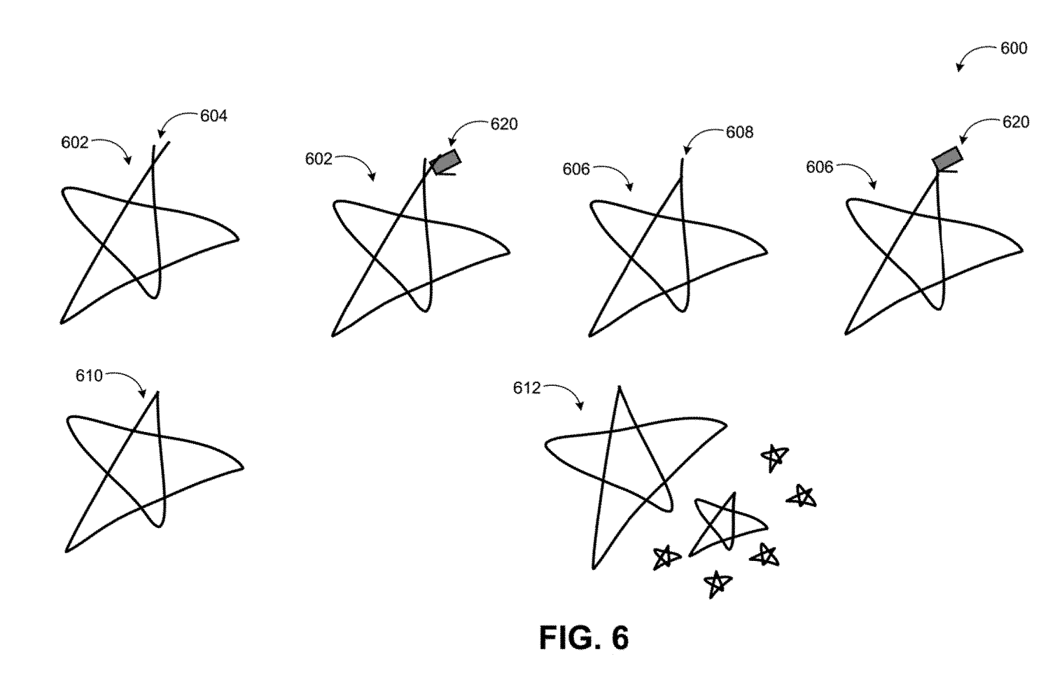

FIG. 6 illustrates example modification of ink entries through deletion of one or more segments.

In addition to standard or default shapes (outline or filled), modification through a segment eraser tool may be used on ink entries as well. Diagram 600 shows a star shaped ink entry 602, where the user may have overextended two of the lines 604 forming the star. Using the segment eraser tool 620, a simple region may be drawn around the first of the two overextended lines leaving the star shaped ink entry with one overextended line 608. Next the same operation may be applied to the remaining overextended line and a clean start shaped ink entry 610 may be achieved. The modified shape may be operated on with operations such as rotation, resizing, recoloring, offset, trimming, etc.

The segment eraser tool may work the one or more segments endpoint to endpoint of underlying shape outlines, on closed shape areas when shapes lack outline, or on dry ink strokes up to intersections with other ink entries.

The examples provided in FIGS. 1 through 6 are illustrated with specific systems, services, applications, modules, and user experience configurations. Embodiments are not limited to environments according to these examples. Modification of shapes and ink entries through deletion of one or more segments may be implemented in environments employing fewer or additional systems, services, applications, modules, and user experience configurations. Furthermore, the example systems, services, applications, modules, and user experience configurations shown in FIG. 1 through 6 may be implemented in a similar manner with other values using the principles described herein.

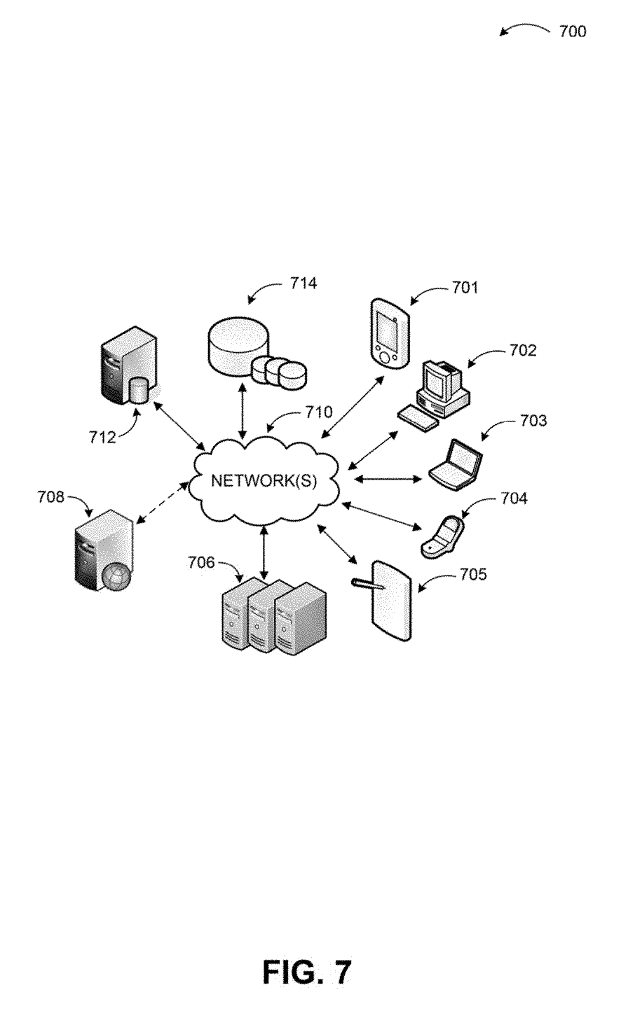

FIG. 7 is a networked environment, where a system according to embodiments may be implemented. In addition to locally installed applications (for example, compliance application 206), a graphics/ink module for modification of shapes through deletion of one or more segments may also be employed in conjunction with hosted applications and services (for example, a productivity service) that may be implemented via software executed over one or more servers 706 or individual server 708. A hosted service or application may communicate with client applications on individual computing devices such as a handheld computer 701, a desktop computer 702, a laptop computer 703, a smart phone 704, a tablet computer (or slate), 705 (‘client devices’) through network(s) 710 and control a user interface presented to users.

Client devices 701-705 are used to access the functionality provided by the hosted service or application. One or more of the servers 706 or server 708 may be used to provide a variety of services as discussed above. Relevant data may be stored in one or more data stores (e.g., data store 714), which may be managed by any one of the servers 706 or by database server 712.

Network(s) 710 may comprise any topology of servers, clients, Internet service providers, and communication media. A system according to embodiments may have a static or dynamic topology. Network(s) 710 may include a secure network such as an enterprise network, an unsecure network such as a wireless open network, or the Internet. Network(s) 710 may also coordinate communication over other networks such as PSTN or cellular networks. Network(s) 710 provides communication between the nodes described herein. By way of example, and not limitation, network(s) 710 may include wireless media such as acoustic, RF, infrared and other wireless media.

Many other configurations of computing devices, applications, data sources, and data distribution systems may be employed to provide modification of shapes and ink entries through deletion of one or more segments. Furthermore, the networked environments discussed in FIG. 7 are for illustration purposes only. Embodiments are not limited to the example applications, modules, or processes.

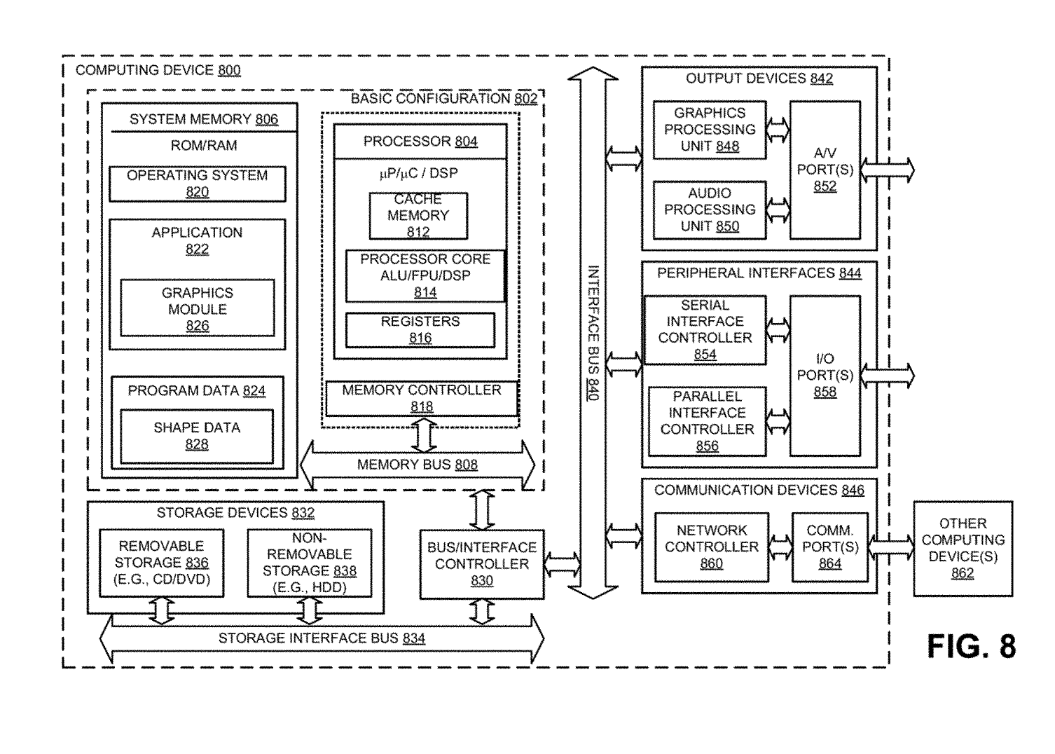

FIG. 8 is a block diagram of an example general purpose computing device, which may be used to provide modification of shapes and ink entries through deletion of one or more segments.

For example, computing device 800 may be used as a server, desktop computer, portable computer, smart phone, special purpose computer, or similar device. In an example basic configuration 802, the computing device 800 may include one or more processors 804 and a system memory 806. A memory bus 808 may be used for communicating between the processor 804 and the system memory 806. The basic configuration 802 is illustrated in FIG. 8 by those components within the inner dashed line.

Depending on the desired configuration, the processor 804 may be of any type, including but not limited to a microprocessor (μP), a microcontroller (μC), a digital signal processor (DSP), or any combination thereof. The processor 804 may include one more levels of caching, such as a level cache memory 812, one or more processor cores 814, and registers 816. The example processor cores 814 may (each) include an arithmetic logic unit (ALU), a floating point unit (FPU), a digital signal processing core (DSP Core), or any combination thereof. An example memory controller 818 may also be used with the processor 804, or in some implementations the memory controller 818 may be an internal part of the processor 804.

Depending on the desired configuration, the system memory 806 may be of any type including but not limited to volatile memory (such as RAM), non-volatile memory (such as ROM, flash memory, etc.) or any combination thereof. The system memory 806 may include an operating system 820, an application 822, and program data 824. The application 822 may include a graphics module 826, which may be an integrated module of the application 822. The graphics module 826 may be configured to modify graphical shapes or ink entries (hand-drawn shapes through touch, gesture, or similar input) through deletion of one or more segments, rotation, resizing, color changes, and comparable ones. Binary shape operations such as union, combination, fragmenting, intersection, and subtraction may be performed on underlying shapes to create new shapes in predictable ways. The graphics module 826 according to embodiments may work from endpoint to endpoint of the underlying shape outlines, on closed shape areas when the shapes have no outline, and on dry ink strokes up to intersections with other ink entries. The program data 824 may include, among other data, shape data 828, such as shapes, segments, ink entries, etc., as described herein.

The computing device 800 may have additional features or functionality, and additional interfaces to facilitate communications between the basic configuration 802 and any desired devices and interfaces. For example, a bus/interface controller 830 may be used to facilitate communications between the basic configuration 802 and one or more data storage devices 832 via a storage, interface bus 834. The data storage devices 832 may be one or more removable storage devices 836, one or more non-removable storage devices 838, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 806, the removable storage devices 836 and the non-removable storage devices 838, are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (for example, one or more output devices 842, one or more peripheral interfaces 844, and one or more communication devices 846) to the basic configuration 802 via the bus/interface controller 830. Some of the example output devices 842 include a graphics processing unit 848 and an audio processing unit 850, which may be configured to communicate to various, external devices such as a display or speakers via one or more A/V ports 852. One or more example peripheral interfaces 844 may include a serial interface controller 854 or a parallel interface controller 856, which may be configured to communicate with external devices such as input devices (for example, keyboard, mouse, pen, voice input device, touch input device, etc.) or other peripheral devices (for example, printer, scanner, etc.) via one or more I/O ports 858. An example communication device 846 includes a network controller 860, which may be arranged to facilitate communications with one or more other computing devices 862 over a network communication link via one or more communication ports 864. The one or more other computing devices 862 may include servers, computing devices, and comparable devices.

The network communication link may be one example of a communication media. Communication media may typically be embodied by computer readable instructions, data structures, program modules, or other data. In a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 800 may be implemented as a part of a general purpose or specialized server, mainframe, or similar computer that includes any of the above functions. The computing device 800 may also be implemented as a personal computer including both laptop computer and non-laptop computer configurations.

Example embodiments may also include methods to provide modification of shapes and ink entries through deletion of one or more segments. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

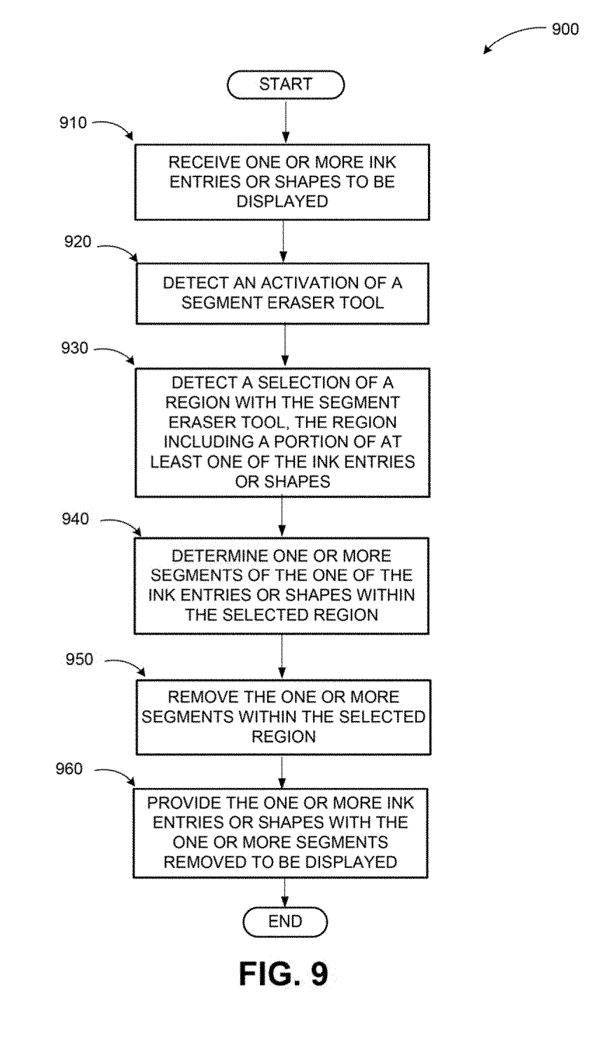

FIG. 9 illustrates a logic flow diagram of a method to provide modification of shapes and ink entries through deletion of one or more segments, according to embodiments.

Process 900 may be implemented on a computing device, server, or other system. An example system may include a server executing a hosted service that includes, among other components, one or more processors configured to execute a graphics application. A user may be enabled to interact with the application through an input device or a touch enabled display of a computing device.

Process 900 begins with operation 910, where one or more ink entries or shapes to be displayed may be received at a modification engine. The modification engine may be part of a productivity service, a word processing application, a presentation application, a graphics application, a note taking application, and similar ones. At operation 920, an activation of a segment eraser tool may be detected. The segment eraser tool may be activated through a drop-down menu, a pop-up menu, a predefined touch input, or a predefined gesture.

At operation 930, a selection of a region with the segment eraser tool may be detected, where the region may include a portion of at least one of the ink entries or shapes. At operation 940, one or more segments of the ink entries or shapes within the selected region may be determined. The one or more segments of the ink entries or shapes within the selected region may then be removed at operation 950. In one example, the one or more segments of the ink entries or shapes within the selected region may be identified, a partial shape that corresponds to the one or more segments may be generated, and the partial shape overlapped with the one or more segments through a binary operation such that the one or more segments within the selected region are removed. At operation 960, the one or more ink entries or shapes with the one or more segments removed may be displayed.

The operations included in process 900 are for illustration purposes. Modification of shapes and ink entries through deletion of one or more segments may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a computing device configured to provide shape modification at a segment level is described. The computing device may include a memory configured to store instructions and a processor coupled to the memory. The processor may execute a modification engine, which may be configured to receive one or more shapes to be displayed; detect an activation of a segment eraser tool detect a selection of a region with the segment eraser tool, the region including a portion of at least one of the shapes; determine one or more segments of the at least one of the shapes within the selected region; and remove the one or more segments of the at least one of the shapes within the selected region from being displayed.

According to other examples, the modification engine may be further configured to receive one or more ink entries to be displayed; detect the activation of the segment eraser tool; detect a selection of another region with the segment eraser tool, the region including a portion of at least one of the ink entries; determine one or more segments of the at least one of the ink entries within the selected region; and remove the one or more segments of the at least one of the ink entries within the selected region from being displayed. The modification engine may also receive an ink entry on a preexisting shape to be displayed; detect the activation of the segment eraser tool; detect a selection of a further region with the segment eraser tool, the region including a portion of a combination of the ink entry and the preexisting shape; determine one or more segments of the combination of the ink entry and the preexisting shape within the selected region; and remove the one or more segments of the combination of the ink entry and the preexisting shape within the selected region from being displayed.

According to further examples, the modification engine may process the one or more shapes with the one or more segments removed as a single object enabling a rotation, a coloring, or a resizing of the one or more shapes together. The modification engine may detect the activation of the segment eraser tool and the selection of the region through one of a touch input, a gesture input, and an eye-tracking input. The one or more shapes may include outline shapes. The one or more shapes may also include filled shapes without an outline. The modification engine may be further configured to render the selected region with the one or more shapes removed transparent. The modification engine may also enable overlay of the one or more shapes with the one or more segments removed over a background such that the background is displayed through the selected region with the one or more shapes removed.

According to other examples, a method executed an a computing device to provide shape modification at a segment level is described. The method may include receiving one or more ink entries or shapes to he displayed; detecting an activation of a segment eraser tool; detecting a selection of a region with the segment eraser tool, the region including a portion of at least one of the ink entries or shapes; determining one or more segments of the at least one of the ink entries or shapes within the selected region; removing the one or more segments of the at least one of the ink entries or shapes within the selected region; and providing the one or more ink entries or shapes with the one or more segments removed to be displayed.

According to some examples, the method may also include combining two distinct ink entries or shapes through one of a union operation, a combination operation, a fragmenting operation, an intersection operation, and a subtraction operation, wherein the one or more segments of the combined ink entries or shapes are removed through the eraser tool. The method may further include performing one or more of a trim operation and an offset operation on the two distinct ink entries or shapes.

According to yet other examples, removing the one or more segments of the at least one of the ink entries or shapes within the selected region may include identifying the one or more segments of the at least one of the ink entries or shapes within the selected region; generating a partial shape that corresponds to the one or more segments of the at least one of the ink entries or shapes within the selected region; and overlapping the partial shape with the one or more segments of the at least one of the ink entries, or shapes within the selected region through a binary operation such that the one or more segments of the at least one of the ink entries or shapes within the selected region are removed. The binary operation may include one of a union operation, a combination operation, a fragmenting operation, an intersection operation, and a subtraction operation. The method may also include displaying a hint of the partial shape as a feedback to a user while the one or more segments of the at least one of the ink entries or shapes within the selected region are removed.

According to further examples, a computer-readable memory device with instructions stored thereon for providing shape modification at a segment level is described. The instructions may include receiving one or more ink entries or shapes to be displayed; detecting an activation of a segment eraser tool; detecting a selection of a region with the segment eraser tool, the region including a portion of at least one of the ink entries or shapes; determining one or more segments of the at least one of the ink entries or shapes within the selected region; removing the one or more segments of the at least one of the ink entries or shapes within the selected region; converting the one or more shapes with the one or more segments removed to a single object to enable a graphic operation on the one or more ink entries or shapes with the one or more segments removed together; and providing the one or more ink entries or shapes with the one or more segments removed to be displayed.

According to yet other examples, the graphic operation may include one or more of resizing, rotation, offset, trimming, coloring, and three dimensional rotation. The segment eraser tool may be activated through one of a drop-down menu, a pop-up menu, a predefined touch input, and a predefined gesture. The instructions may also include determining the one, or more segments endpoint to endpoint of underlying shape or ink entry outlines, on closed shape areas when shapes lack outline, or on dry ink strokes up to intersections with other ink entries. The instructions may further include in response to failing to identify the one or more segments within the selected region; implementing an intelligent learning algorithm to analyze a history associated with a determination of the one or more segments during a previous time period; identifying a default shape similar to an ink entry or shape within the selected region; and displaying the default shape.

According to some examples, a means for providing shape modification at a segment level is described. The means may include a means for receiving one or more ink entries or shapes to be displayed; detecting an activation of a segment eraser tool; a means for detecting a selection of a region with the segment eraser tool, the region including a portion of at least one of the ink entries or shapes; a means for determining one or more segments of the at least one of the ink entries or shapes within the selected region; a means for removing the one or more segments of the at least one of the ink entries or shapes within the selected region; and a means for providing the one or more ink entries or shapes with the one or more segments removed to be displayed.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A computing device configured to provide shape modification at a segment level, the computing device comprising:
a memory configured to store instructions; and
a processor coupled to the memory, the processor configured to execute a modification engine, wherein the modification engine is configured to:
receive a first two-dimensional shape to be displayed;
detect an activation of a segment eraser tool;
detect a selection of a two-dimensional region with the segment eraser tool, the two-dimensional region including a portion of the first two-dimensional shape;
identify one or more segments and endpoints of the one or more segments of the first two-dimensional shape within the selected two-dimensional region;
remove the one or more segments of the first two-dimensional shape between the endpoints to create a second two-dimensional shape, wherein the second two-dimensional shape is to the removed one or segments; and
overlay the second two-dimensional shape on a background such that the background is applied to the transparent region, wherein the background includes one or more of a color and a texture.

2. The computing device of claim 1, wherein the modification engine is further configured to:
receive a first two-dimensional ink entry to be displayed;
detect the activation of the segment eraser tool;
detect a selection of another two-dimensional region with the segment eraser tool, the other two-dimensional region including a portion of the first two-dimensional ink entry;
identify one or more segments and endpoints of the one or more segments of the first two-dimensional ink entry within the selected other two-dimensional region; and
remove the one or more segments of the first two-dimensional ink entry between the endpoints.

3. The computing device of claim 2, wherein the modification engine is further configured to:
receive the first two-dimensional ink entry on the first two-dimensional shape to be displayed;
detect the activation of the segment eraser tool;
detect a selection of a further two-dimensional region with the segment eraser tool, the further two-dimensional region including a portion of a combination of the first two-dimensional ink entry and the first two-dimensional shape;
identify one or more segments and the endpoints of the one or more segments of the combination of the two-dimensional ink entry;and the pre existing first two-dimensional shape within the selected further two-dimensional region; and
remove the one or more segments of the combination of the first two-dimensional ink entry and the first two-dimensional shape between the endpoints.

4. The computing device of claim 1, wherein the modification engine is further configured to:
process the second two-dimensional shape with the one or more segments removed as a single object enabling a rotation, a coloring, or a resizing of the shape.

5. The computing device of claim 1, wherein the modification engine is configured to detect the activation of the segment eraser tool and the selection of the two-dimensional region through one of a touch input, a gesture input, and an eye-tracking input.

6. The computing device of claim 1, wherein the first two-dimensional shape includes an outline shape.

7. The computing device of claim 1, wherein the first two-dimensional shape includes a filled shape without an outline.

8-9. (canceled)

10. A method executed on a computing device to provide shape modification at a segment level, the method comprising:
receiving a first two-dimensional shape to be displayed;
detecting an activation of a segment eraser tool;
detecting a selection of a two-dimensional region with the segment eraser tool, the two-dimensional region including a portion of the first two-dimensional shape;
identifying one or more segments and endpoints of the one or more segments of the first two-dimensional shape;
removing the one or more segments of the first two-dimensional shape between the endpoints to create a second two-dimensional shape, wherein the second two-dimensional shape is comprised of the first two-dimensional shape with a transparent region corresponding to the removed one or segments;
overlaying the second two-dimensional shape on a background such that the background is applied to the transparent region, wherein the background includes one or more of a color and a texture: and
providing the second two-dimensional shape overlaid on the background to be displayed.

11. The method of claim 10, further comprising:
combining two distinct two-dimensional shapes through one of a union operation, a combination operation, a fragmenting operation, an intersection operation, and a subtraction operation, wherein one or more segments of the combined two-dimensional ink entries or shapes are removed through the eraser tool.

12. The method of claim 11, further comprising:
performing a trim operation and an offset operation on the first two-dimensional shape.

13. The method of claim 10, wherein removing the one or more segments of the first two-dimensional shape between the endpoints to create the second two-dimensional shape comprises:
generating a partial two-dimensional shape that corresponds to the one or more segments and endpoints of the one or more segments of the first two-dimensional shape; and
overlapping the partial two-dimensional shape with the one or more segments and endpoints of the one or more segments of the first two-dimensional shape through a binary operation such that the one or more segments of the first two-dimensional are removed between the endpoints to create the second two-dimensional shape.

14. The method of claim 13, wherein the binary operation includes one of a union operation, a combination operation, a fragmenting operation, an intersection operation, and a subtraction operation.

15. The method of claim 13, further comprising:
displaying a hint of the partial two-dimensional shape as a feedback to a user while the one or more segments of the first two-dimensional shape are removed between the endpoints.

16. A computer-readable memory device with instructions stored thereon for providing shape modification at a segment level, the instructions comprising:
receiving a first two-dimensional shape to be displayed;
detecting an activation of a segment eraser tool;
detecting a selection of a two-dimensional region with the segment eraser tool, the two-dimensional region including a portion of the first two-dimensional shape;
identifying one or more segments and endpoints of the one or more segments of the first two-dimensional shape within the selected two-dimensional region;
removing the one or more segments of the first two-dimensional shape between the endpoints to create a second two-dimensional shape, wherein the second two-dimensional shape is comprised of the first two-dimensional shape with a transparent region corresponding to the removed one or segments;
converting the second two-dimensional to a single object to enable a graphic operation on the second two-dimensional shape;
overlaying the second two-dimensional shape on a background such that the background is applied to the transparent region, wherein the background includes one or more of a color and a texture; and
providing the second two-dimensional shape overlaid on the background to be displayed.

17. The computer-readable memory device of claim 16, wherein the graphic operation includes one or more of resizing, rotation, offset, trimming, coloring, and three dimensional rotation.

18. The computer-readable memory device of claim 16, wherein the segment eraser tool is activated through one of a drop-down menu, a pop-up menu, a predefined touch input, and a predefined gesture.

19. (canceled)

20. The computer-readable memory device of claim 16, wherein the instructions further comprise:
in response to failing to identity the one or more segments or the endpoints of the one or more segments within the selected two-dimensional region;
implementing an intelligent learning algorithm to analyze a history associated with a determination of the one or more segments and the endpoints of the one or more segments during a previous time period;
identifying a default shape similar to a two-dimensional shape within the selected region; and
displaying the default shape.
